(19) United States
(12) Patent Application Publication
(10) Pub. No.: US 2005/0098136 A1
(43) Pub. Date: May 12, 2005

(54) ARCHITECTURE TO INTEGRATE IONIZATION DETECTION ELECTRONICS INTO AND NEAR A DIESEL GLOW PLUG

(75) Inventors: Guoming George Zhu, Novi, MI (US); James Raymond Winkelman, Bloomfield, MI (US)

Correspondence Address: BRINKS HOFER GILSON & LIONE/CHICAGO/COOK, PO BOX 10395, CHICAGO, IL, 60610, US

(73) Assignee: Visteon Global Technologies, Inc.

(21) Appl. No.: 10/872,309

(22) Filed: Jun. 18, 2004

Related U.S. Application Data
(60) Provisional application No. 60/518,831, filed on Nov. 10, 2003.

(51) Int. Cl. F02P 19/02

(52) U.S. Cl. 123/145 A; 219/267; 219/270

(57) ABSTRACT

A glow plug for a diesel engine comprises a glow plug body, and a glow rod connected to the glow plug body. The glow rod has an inner heating element connected between an engine ground and a heating element power terminal. Located on a front end surface of the glow rod is an ionization detection element. An ionization detection circuit is integrated within or near the glow plug body to connect the ionization detection element to an ionization detection collector, and communicate an ionization signal to an engine control unit via the detection collector.

### CROSS REFERNCE TO RELATED APPLICATION

This application claims the benefit of U.S. Provisional Application No. 60/518,831, entitled “Architecture to Integrate Ionization Detection Electronics Into and Near a Diesel Glow Plug,” filed on Nov. 10, 2003, which is incorporated herein by reference.

### FIELD OF THE INVENTION

The present invention relates, generally, to glow plugs, and particularly, to an architecture to integrate ionization detection electronics into and near a diesel glow plug.

### BACKGROUND

Vehicles, which are powered by compression-ignition diesel fuel engines, typically emit high levels of oxides of nitrogen (NOx) and black particulate smoke during operation. The black smoke is not only unsightly, but has been qualified as an environmental and human hazard.

Compression Ignited (CI) diesel engines may have better fuel economy than Spark Ignited (SI) gasoline engine, primarily due to a high compression ratio created inside the diesel engines. However, as stated above, these diesel engines may have much higher emissions than gasoline engines due to a higher combustion temperature. Typically, there are two main approaches for implementing emission reduction, namely, improving the combustion process and using after-treatment processes. Many technologies have been used to meet tightening emission standards, such as high fuel injection pressure, multiple fuel injections and continuous fuel injection rate shaping, cooled EGR (Exhaust Gas Re-circulation), etc. Also, since diesel engine runs at a lean air-to-fuel ratio, the after treatment system cost is much higher than a three-way catalyst system used in gasoline engines that operate at a stoichiometric air-to-fuel ratio. As such, an approach to control diesel engine combustion process for improved emissions may be more favorable due to a relatively lower cost.

In order to control the diesel combustion process precisely, closed-loop control of diesel fuel injection system may be used. As such, an in-cylinder sensor detects the combustion process. Further, an in-cylinder pressure sensor provides substantial combustion information that can be used for closed-loop combustion control and optimization. However, a pressure sensor cost and reliability may prevent it from being used in a massive production environment. One other in-cylinder combustion sensing technique is known as an in-cylinder ionization sensing for the combustion process in the diesel engine.

The in-cylinder ionization sensing technique detects in real time start of combustion and other combustion information, enabling a fuel control strategy to change from open to closed loop. Thus, the in-cylinder ionization sensing technique provides combustion information for all speed and load demands imposed on the diesel engine. An in-cylinder ionization signal can also provide an alternative method of obtaining in-cylinder combustion information that can be used for closed-loop combustion control. The closed-loop combustion control, utilized with the in-cylinder ionization signal, may support changes in start of combustion delays brought about by timely alterations or changes in fuel composition, air characteristic (dry, humid, and low or high oxygen composition), and engine and fuel temperature. Therefore, the in-cylinder ionization sensing technique may improve the ability to control the combustion process of a diesel engine.

Previous solutions have combined an ionization detection function with the glow plug. Key benefits of this combination are that engine modifications may not be required and also that the location of the glow plug is beneficial for sensing and is a feasible technology for production. However, due to thermal and magnetic conditions in or near the glow plug, typical ionization conditioning circuitry has been positioned at substantial protecting distances from the glow plug. Unfortunately, these protective distances further degrade a typically weak signal, and thus reduce the signal-to-noise ratio of the detected ionization signal before reaching the ionization conditioning circuitry.

Therefore, it would be advantageous to integrate the ionization detection and conditioning circuitry in or near its detection probe (glow plug) resulting in an improved signal-to-noise ratio of the ionization detection that can be used for closed-loop combustion control signal. As a result, a diesel engine glow plug having an architecture that integrates the ionization detection sensing and conditioning circuitry in or near the glow plug, and improves the ability to closed-loop control the in-cylinder combustion, while also being easy to manufacture, would be realized.

### BRIEF SUMMARY

The present invention is defined by the appended claims. This description summarizes some aspects of the present embodiments and should not be used to limit the claims.

As provided herein, in a preferred embodiment, a glow plug for a diesel engine includes a glow plug body, and a glow rod connected to the glow plug body. The glow rod has an inner heating element that is connected between an engine ground and a heating element power terminal. Located on a front end surface of the glow rod is an ionization detection element. An ionization detection circuit is integrated within the glow plug body and connects the ionization detection element to an ionization detection collector and communicates an ionization signal to an engine control unit via the detection collector.

In another preferred embodiment, a glow plug for a diesel engine comprises a glow plug body, and a glow rod connected to the glow plug body. The glow rod has an inner heating element connected between an engine ground and a heating element power terminal. Located on a front end surface of the glow rod is an ionization detection element. An ionization detection circuit is situated outside the glow plug body and connects the ionization detection element to an ionization detection collector and communicates an ionization signal to a engine control unit via the detection collector.

Further aspects and advantages of the invention are described below in conjunction with the present embodiments.

### BRIEF DESCRIPTION OF THE DRAWINGS

The invention, together with the advantages thereof, may be understood by reference to the following description in conjunction with the accompanying figures, which illustrate some embodiments of the invention.

FIG. 1 is a schematic cross-sectional view of an embodiment of a glow plug in accordance with the present invention;

FIG. 2 is a schematic diagram of a circuit integrating an ionization detection architecture and power supply of the glow plug embodiment of FIG. 1, in accordance with the present invention; and

FIG. 3 is a schematic cross-sectional view of another embodiment of a glow plug in accordance with the present invention.

### DETAILED DESCRIPTION OF THE PRESENT INVENTION

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

Typical diesel engines, especially light duty diesel engines, are equipped with a glow plug in each cylinder to improve engine cold start performance. The glow plug can be redesigned or modified to add ionization detection electrode and circuitry, so that the glow plug may possess dual functionalities: heating in-cylinder gas mixture and detecting ionization current during an engine combustion process.

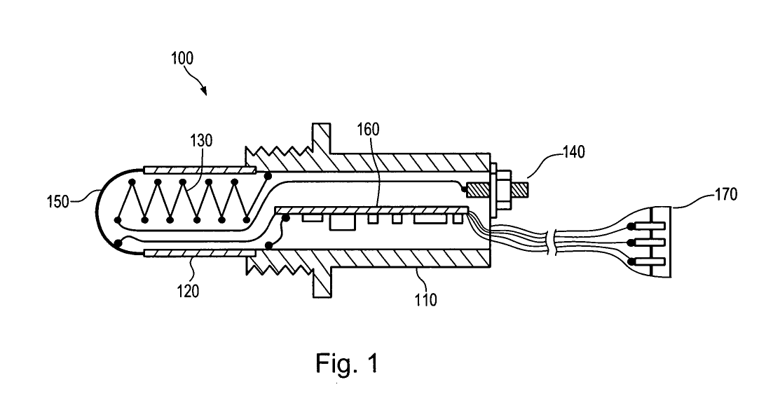

Referring to FIG. 1, a schematic lengthwise cross-sectional view of an embodiment of a glow plug 100 in accordance with the present invention is shown. The glow plug 10 comprises a glow plug body 110, and a glow rod 120 connected to the glow plug body 110. The glow plug body 110 is grounded via the engine (not shown). The glow rod 120 has an inner heating element 130 connected between the glow plug body 110 and a heating element power terminal 140. An ionization detection element or electrode 150 is positioned on a front tip end of the glow rod 120, and may define a substantially circular portion of the tip end of the glow plug 100. An ionization detection circuit 160 is located near the glow plug body 110, and connects the ionization detection element 150 to an ionization detection collector 170 to relay an ionization signal to a engine control unit (not shown) via the detection collector 170.

Fuel combustion in a diesel engine cylinder involves a plurality of complex chemical reactions. The plurality of chemical reactions may produce free electrons by a process called chemi-ionization. The chemi-ionization process may occur during an exothermic reaction when a released reaction energy is large enough to ionize one of the reaction products. As a temperature rises in the engine cylinders, additional free electrons are produced by thermal ionization processes. Typically, the ions produced by chemi-ionization and thermal ionization processes may recombine with an electron and form a more stable molecule. By introducing a positive DC bias voltage inside the engine cylinders, an electrical field is created. The electrical field will attract the negative charged electrons to the positive pole and a current is generated from the sensor to the electrical ground. The electrical ground may be defined by a piston, the cylinder head and walls. The current is traditionally called an “ion current”. Thus, during the fuel combustion, the ion current flows through the combustion chamber to engine electrical ground. The ion current is then detected and measured inside the ionization detection circuit, creating an ionization signal. The ionization current is typically proportional to an applied sensor voltage and the ions in the vicinity of the sensor.

The in-cylinder ionization detection circuit 160 utilizes an in-cylinder ionization current to detect ions generated during the engine combustion process by applying a bias voltage between the glow plug ionization detection electrode 150 and an engine ground (not shown). The low current nature of the ionization current, having microampere levels, may make the detection system substantially sensitive to environment noises, such as RF (Radio Frequency) noise, magnetic field noise, and the like. In order to obtain a high signal-to-noise ratio ionization current signal, it may be useful to minimize a distance between the ionization detection electrode and a corresponding detection signal conditioning circuit. That is, minimizing an antenna size that receives or captures both electric and magnetic environmental noises. As such, ionization glow plug architecture is provided to improve the signal-to-noise ratio of the detected ionization current by integrating the ionization detection and signal conditioning circuit into or near the diesel glow plug.

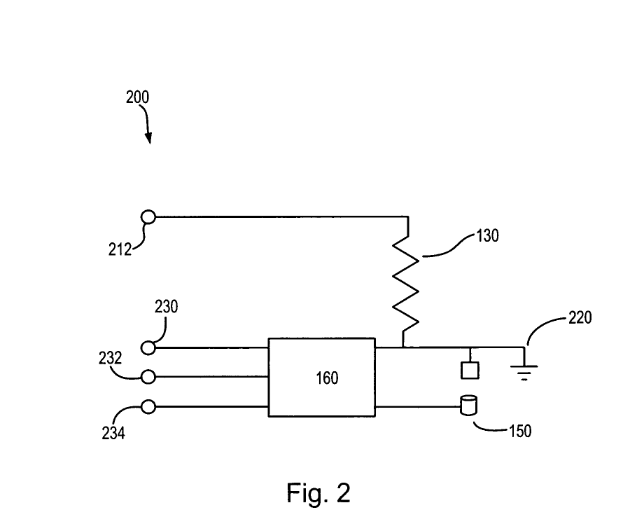

In the in-the-glow-plug configuration, the ionization detection and signal conditioning circuit 160 is integrated into the glow plug body or housing 110, as shown in FIG. 1. Now referring to FIG. 2, the ionization detection and signal conditioning circuit 200 of the integrated system is shown with the heating element 130 (typically a heating wire) of the glow plug 100 connected between the engine ground 220 and its controlled input 140, indicated as a heating element power pin 212. The glow plug 100 is turned on when the heating element power pin 212 is connected to the vehicle battery through a controlled switch (not shown) such as a relay, thereby heating up a nearby in-cylinder gas mixture. As shown, the ionization detection circuit 160 has five connecting pins. A first pin connects the ionization detection electronics circuit 160 to a vehicle power battery lead 230, referred to as V_{B}. A second pin serves to ground the ionization detection electronics circuit 160 to vehicle battery ground 234, referred to as VGND. A third pin connects the ionization detection electronics circuit 160 to the engine control unit (not shown) to communicate the ionization signal. A fourth pin connects the engine ground 220, also referred to as ionization detection bias voltage ground, to the ionization detection electronics circuit 160. Finally, a fifth pin connects the ionization detection electrode 150 to the ionization detection electronics circuit 160 to communicate the detected ionization signal 232.

Due to a high current nature of the glow plug heating element 130, for example at times over hundreds of amperes, the controlled input “heating element power” pin is separated from the ionization detection connector to avoid ground shift, see FIG. 1. The ionization detection connector 170 consists of three pins, namely the first pin through the third pin, and ionization detection bias voltage outputs, namely the fourth pin and the fifth pin, are connected to the glow plug housing 110, i.e. engine ground, and ionization detection electrode 150. The ionization detection and signal conditioning circuit has two basic functions. One of the two basic functions may serve to generate a bias voltage to be applied between the ionization detection electrode and the engine ground, and the other basic function may amplify and condition the detected ionization current to a desirable signal level that may be suitable to be transmitted through an engine harness (not shown).

One advantage of the in-the-glow-plug architecture, i.e. integrated architecture, is that the ionization detection and signal conditioning circuit has a desirably reduced, i.e. preferably minimal, distance to the detection electrode. The reduced distance of travel for the ionization signal may lead correspondingly to a substantially improved signal-to-noise ratio. With the in-the-glow-plug architecture, the ionization detection and signal conditioning circuit 160 is very close to the glow plug heating element 130 which may lead to high temperature requirements of the detection circuit electronics. As such, the ionization detection and signal conditioning circuit 160 typically includes electronic components that can sustain high temperature duty cycles, which typically occur during on-and-off operations of the glow plug, to provide a desirable reliability of the ionization detection system. Further, an antenna-like behavior of a wire connection between the glow plug 100 and the ionization detection and conditioning circuit 160 that may receive or capture both electric and magnetic environmental noises is thereby minimized.

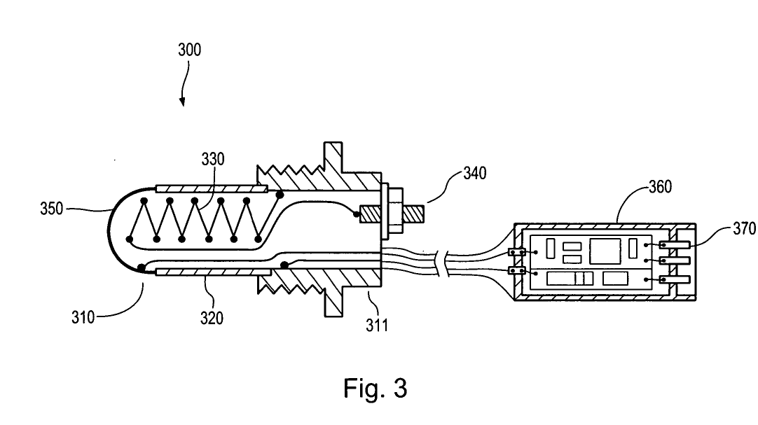

Now referring to FIG. 3, another embodiment of the ionization glow plug architecture is shown to provide an improved signal-to-noise ratio of the detected ionization current by integrating the ionization detection and signal conditioning circuit near the diesel glow plug. This near-the-glow-plug architecture is provided as an alternate design to the above described in-the-glow-plug architecture to highlight an additional advantage of the present invention. As shown in FIG. 3, the ionization detection and conditioning circuit 360 is integrated into the ionization detection connector 370. The electrical circuitry 360 of the near-the-glow-plug architecture is substantially similar to the one corresponding to the in-the-glow-plug architecture, and may be subsequently differentiated only by its respective assembly. That is, the ionization detection and conditioning circuit 360 resides inside of the ionization detection connector 370 instead of the glow plug 310. As a result, an impact of the on-and-off operation temperatures of the glow plug 310 may be minimized, and a correspondingly operating temperature for the ionization detection and conditioning circuit 360 is substantially reduced, which may lead to an improved reliability and low manufacturing cost of the near-the-glow-plug architecture. Further, an antenna-like behavior of a wire connection between the glow plug 310 and the ionization detection connector 370 that may receive or capture both electric and magnetic environmental noises, is thereby reduced.

Therefore, the above discussed advantages of integrating the ionization detection and conditioning circuitry into or near a diesel glow plug are to improve the signal-to-noise ratio of the detected ionization signal. Further, the ionization current is relatively weak, typically at microampere levels, and minimizing the connection distance between ionization detection electrode and its signal conditioning circuitry improves the desirable signal-to-noise ratio. Still further, the advantage of integrating the ionization detection electronics into the ionization detection connector is to improve the thermal requirements of the ionization detection circuitry due to the fact that the temperature of a diesel glow plug, when it is tuned on, typically gets very high within the glow plug housing.

The foregoing discussion discloses and describes two exemplary embodiments of the present invention for the purpose of illustrating the manner in which the invention is used. One skilled in the art will readily recognize from such discussion, and from the accompanying drawings that the implementation of various changes, modifications and variations can be made therein without departing from the true spirit and fair scope of the invention as described, disclosed and claimed herein.

1. A glow plug for a diesel engine, comprising:
a glow plug body;
a glow rod connected to the glow plug body, the glow rod having an inner heating element connected between an engine ground and a heating element power terminal;
an ionization detection element positioned on a front end outer surface of the glow rod; and
an ionization signal circuit positioned in proximity to the ionization detection element in relation to the glow plug, the ionization signal circuit being directly connected to the ionization element independently of the heating element is configured to connect the ionization detection element to an ionization detection collector, and relay an ionization signal to an engine control unit via the detection collector.

2. The glow plug for a diesel engine as in claim 1, wherein the ionization signal circuit is enclosed within the glow plug body.

3. The glow plug for a diesel engine as in claim 2, wherein the ionization signal circuit is configured to condition the ionization signal.

4. The glow plug for a diesel engine as in claim 2, wherein the
ionization detection element and ionization signal circuit comprises electronic elements with thermal requirements that correspond to high temperature duty cycles of the glow plug, which occur during on-and-off operations, thereby realizing a desirable reliability of the ionization signal detection.

5. The glow plug for a diesel engine as in claim 4, wherein the realized reliability of the ionization signal detection enhances a signal-to-noise ratio of the ionization signal.

6. The glow plug for a diesel engine as in claim 2, wherein the ionization signal is communicated to a control unit of the diesel engine utilizing a closed-loop control of an in-cylinder combustion of the diesel engine to improve the in-cylinder combustion.

7. The glow plug for a diesel engine as in claim 1, wherein the ionization signal circuit is located outside the glow plug body.

8. The glow plug for a diesel engine as in claim 7, wherein the ionization signal circuit is configured to condition the ionization signal.

9. The glow plug for a diesel engine as in claim 7, wherein the glow plug and the ionization detection circuit are connected by a connector wire, the connector wire is configured to substantially reduce influence of at least electric and magnetic environmental noises.

10. The glow plug for a diesel engine as in claim 9, wherein the influence reduction of the at least electric and magnetic environmental noises substantially improves a signal-to-noise ratio of the ionization signal.

11. The glow plug for a diesel engine as in claim 7, wherein the ionization signal is communicated to a control unit of the diesel engine utilizing a closed-loop control of an in-cylinder combustion of the diesel engine to improve the in-cylinder combustion.

12. A glow plug for a diesel engine, comprising:
a glow plug body;
a glow rod connected to the glow plug body, the glow rod having an inner heating element connected between an engine ground and a heating element power terminal;
an ionization detection element positioned on a front end outer surface of the glow rod; and
an ionization signal circuit positioned in proximity to the ionization detection element in relation to the glow plug, the ionization signal circuit connected directly to the ionization element independently of the heating element is configured to connect the ionization detection element to an ionization detection collector, and relay an ionization signal to an engine control unit via the detection collector,
wherein the ionization signal circuit is enclosed within the glow plug body.

13. The glow plug for a diesel engine as in claim 12, wherein the ionization signal circuit is configured to condition the ionization signal.

14. The glow plug for a diesel engine as in claim 12, wherein the ionization detection element and ionization signal circuit comprises electronic elements with thermal requirements that correspond to high temperature duty cycles of the glow plug, which occur during on-and-off operations, thereby realizing a desirable reliability of the ionization signal detection.

15. The glow plug for a diesel engine as in claim 14, wherein the realized reliability of the ionization signal detection enhances a signal-to-noise ratio of the ionization signal.

16. The glow plug for a diesel engine as in claim 12, wherein the ionization signal is communicated to a control unit of the diesel engine utilizing a closed-loop control of an in-cylinder combustion of the diesel engine to improve the in-cylinder combustion.
